(19) United States
(12) Patent Application Publication
(10) Pub. No.: US 2012/0138764 A1
(43) Pub. Date: Jun. 7, 2012

(54) CLAMP FOR A PLATE ELEMENT, ESPECIALLY FOR A PHOTOVOLTAIC MODULE

(75) Inventor: Lorcan KEMPLE, Hard (AT)

(73) Assignee: Hilti Aktiengesellschaft, Schaan (LI)

(21) Appl. No.: 13/309,624

(22) Filed: Dec. 2, 2011

(30) Foreign Application Priority Data
Dec. 3, 2010 (DE) DE102010062384.9

(51) Int. Cl. H01Q 1/12

(52) U.S. Cl. 248/316.1

(57) ABSTRACT

A clamp for at least one plate element, with a first clamp part and a second clamp part, the clamp parts adjustable relative to each other between an open position and a clamping position for the plate element, and with at least one elastomer profile that is arranged between the two clamp parts and that has an area with a U-shaped cross section for gripping the plate element. The elastomer profile has a clamping section that is clamped between the two clamp parts when the clamp parts are in the clamping position.

This claims the benefit of German Patent Application DE 10 2010 062 384.9, filed Dec. 3, 2010 and hereby incorporated by reference herein.

The invention relates to a clamp for at least one plate element, especially for at least one photovoltaic module, preferably a thin-layer photovoltaic module. A clamp of the generic type is configured with a first clamp part and a second clamp part, whereby the clamp parts can be adjusted relative to each other between an open position and a clamping position for the plate element, and with at least one elastomer profile that is arranged for placement on the plate element between the two clamp parts.

### BACKGROUND

A clamp of the generic type for photovoltaic modules is disclosed in international patent WO 2009/086150 A1. Other clamps for photovoltaic modules are known from European patent application 2 090 847 A2, German utility model DE 20 2009 012 870 U1 and German utility model DE 20 2009 014 048 U1.

Clamps for photovoltaic modules are known in which the photovoltaic module is laid between elastomer elements, and the elastomer elements are then pressed together with the photovoltaic module by means of two clamp parts, as a result of which the photovoltaic module is secured onto the clamp parts.

However, it has been found that certain clamps according to the state of the art can exhibit inadequate clamping properties over the long run.

### SUMMARY OF THE INVENTION

It is an object of the present invention to provide a clamp that is especially reliable, particularly for operation over the long term.

The present invention provides a clamp characterized in that the elastomer profile has a clamping section that, especially in order for the elastomer profile to be secured on the clamp parts, is clamped between the two clamp parts when the clamp parts are in the clamping position. The elastomer profile can be secured on the clamp parts especially, at least partially, with a non-positive connection.

A fundamental idea of the invention is that the elastomer profile has a clamping section that is clamped directly (i.e. not via the plate element) by the two clamp parts when the two clamp parts are in the clamping position. Due to this clamping, the elastomer profile is mechanically secured on the clamp parts, thereby preventing an undesired movement of the elastomer profile relative to the clamp parts, for example, owing to different coefficients of thermal expansion of the photovoltaic module and its support structure. There is no need for an adhesive connection, which might deteriorate with age and thus might exhibit inadequate clamping properties over the long run.

The geometry of the clamp according to the invention accounts for the fact that the technician clamps the elastomer profile between the two preferably metal clamp parts when he is tightening the clamp, i.e. when he places the clamp parts into the clamping position. This greatly reduces the risk that the elastomer profile will fall out during the service life of the installation because of dynamic effects.

According to the invention, the expression “open position” refers to a position in which the plate element is released and/or the expression “clamping position” refers to a position in which the clamp is holding the plate element.

Suitable clamp parts are metal parts, especially aluminum parts. However, clamp parts made of plastic can also be provided. The clamp parts can especially be extruded profiles.

It is especially preferable for the elastomer profile to have an area with a U-shaped cross section for gripping the plate element. According to this embodiment, the elastomer element that is on the top of the plate element is configured in one piece with the elastomer element that is at the bottom of the plate element. Thus, the elastomer element that is on the top of the plate element as well as the elastomer element that is at the bottom of the plate element can be secured via the clamping section that is preferably adjacent to the U-shaped area. Additional adhesive connections are thus superfluous. In particular, it is provided according to the invention that there is no material connection between the elastomer profile and the clamp parts, especially no adhesive connection, as a result of which the production work is further reduced.

Moreover, it is advantageous for the first clamp part to have a web that extends from the first clamp part to the second clamp part and that clamps the clamping section when the clamp parts are in the clamping position. Such a web makes it possible to achieve an especially small contact surface with the elastomer profile and thus an excellent clamping effect. For analogous reasons, in addition or as an alternative, it can be provided that the second clamp part has a web that extends from the second clamp part to the first clamp part and that clamps the clamping section when the clamp parts are in the clamping position. If there are two webs, these webs are suitably positioned one above the other, so that the webs, like the jaws of a pair of pliers, pinch the elastomer profile when the two clamp parts are adjusted relative to each other in the vertical direction and are moved into the clamping position.

Suitably, the elastomer profile has an area with a T-shaped cross section. Such a T-shaped area makes it possible to form a positive connection between the elastomer profile and the clamp parts, thereby additionally securing the elastomer profile. It is preferable for at least one part of the clamping section to be located on the T-shaped area, especially on the middle leg of the T-shaped area, as a result of which an especially compact arrangement is obtained.

Moreover, a preferred embodiment is one in which the two clamp parts, together with the two webs, form an insertion groove where the area of the elastomer profile with the T-shaped cross section is accommodated. According to this embodiment, the webs serve not only to clamp the elastomer profile but also to hold the T-shaped area of the elastomer profile with a positive connection, so that the installation size of the clamp can be further reduced.

Another preferred embodiment of the invention is that the elastomer profile has at least one hole in the vicinity of the clamping section and/or in the middle leg of the T-shaped area. Such a hole can absorb deformations that occur when the clamping section is clamped and can yield especially well-defined shape changes. The at least one hole can especially run along the at least one web, which can be advantageous, among other things, in terms of the production work required.

Moreover, it can be provided according to the invention that the first clamp part has at least one projection that, especially in the vertical direction, faces the second clamp part, limiting a movement, especially a vertical movement, of the second clamp part towards to the first clamp part and that rests against the second clamp part when in the clamping position. On the one hand, such a projection forms a stop that limits the clamping procedure and thus protects the plate element against being overloaded. On the other hand, the projection defines the clamping position so that an especially reliable assembly is ensured.

An advantageous embodiment of the invention is one in which the elastomer profile has a spring lip that is preferably arranged in the area with a U-shaped cross section and that preferably pre-tensions the clamp parts and/or holds them in the open position. Since the spring lip holds the clamp parts open, the assembly of the clamp is especially simple. The spring lip is advantageously configured in one piece with the elastomer profile, thus entailing very little production work.

Moreover, it is preferred for a screw to pass through the two clamp parts and for this screw to be locked with a rail nut in order to secure the clamp to a rail, especially to a C-profile rail. According to this embodiment, when the screw is tightened, the two clamp parts can be moved from the open position into the clamping position and the clamp can be secured on the profile rail, which allows an especially fast assembly. Moreover, the spring lip can pre-tension the rail nut vis-à-vis the clamp part that is adjacent to the rail nut. This establishes a preliminary assembly position in which the clamp is temporarily held on the rail by the pre-tension applied by the spring lip, so that the technician no longer has to hold the clamp. Thus, during the installation, the technician positions the clamp on the rail in such a way that the rail nut is in the channel of the rail, and he then turns the rail nut by 90° so that it runs crosswise to the channel. The pretension that the spring lip applies onto the rail nut via the screw temporarily holds the clamp on the rail so that the technician can now let go of the clamp and can use both hands to insert the plate element into the clamp. By tightening the screw, the technician can then secure the plate element on the clamp and can permanently secure the clamp on the rail.

### BRIEF DESCRIPTION OF THE DRAWINGS

The invention will be explained below with reference to preferred embodiments that are shown schematically in the accompanying figures. The figures show the following:

FIG. 1 a perspective view of a first embodiment of a clamp according to the invention, in the open position;

FIG. 2 a perspective view of the embodiment shown in FIG. 1, in the clamping position;

FIG. 3 a perspective view of the embodiment shown in FIG. 1, in the clamping position in an oblique view from below;

FIG. 4 a perspective view of a second embodiment of a clamp according to the invention in the open position; and

FIG. 5 a schematic cross sectional view of a clamp according to the invention, on a C-profile rail.

### DETAILED DESCRIPTION

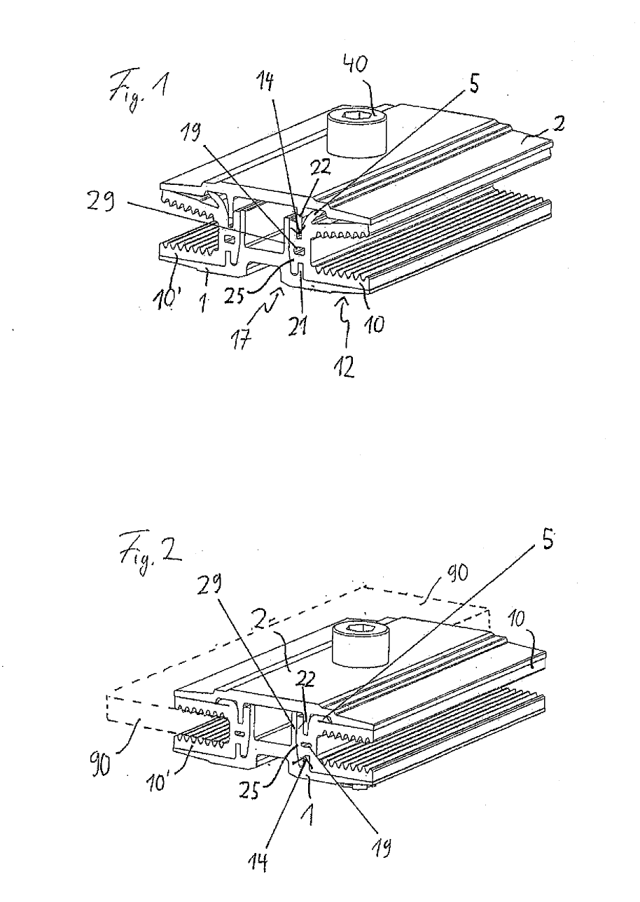

A first embodiment of a clamp according to the invention is shown in FIGS. 1 to 3. The embodiment shown in FIGS. 1 and 2 is configured as a middle clamp for affixing two plate elements and thus has two elastomer profiles 10, 10′ that each hold a plate element. For the sake of clarity, such a plate element 90 is only shown in FIG. 2, where such a plate element is depicted only in the second elastomer profile 10′.

The clamp of FIG. 1 is configured to be essentially mirror-symmetrical. Consequently, only the elastomer profile or section 10 and its arrangement shown on the right-hand side of the figure will be described in greater detail. The second elastomer profile 10′ is configured and arranged analogously.

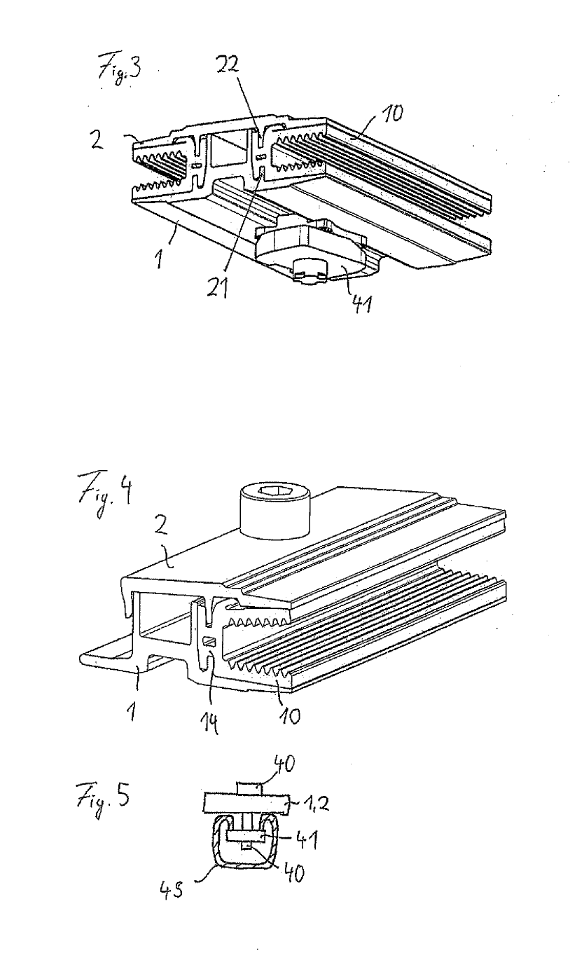

The depicted clamp has a first clamp part 1 and a second clamp part 2, which can be moved relative to each other in the vertical direction. A screw 40 runs in the vertical direction through the two clamp parts 1 and 2, and this screw 40 serves to tighten the two clamp parts 1 and 2. The head of the screw 40 rests against the second clamp part 2. The screw is locked on its shank with a rail nut 41 (FIG. 3) that is arranged adjacent to the first clamp part 1. As is schematically shown in FIG. 5, the rail nut 41 serves to secure the two clamp parts 1 and 2 with a positive connection to a C-profile rail 45.

When the screw 40 is tightened, the two clamp parts 1 and 2 can be moved relative to each other from an open position, which is shown in FIG. 1 and in which the plate elements 90 are released, into a clamping position, which is shown in FIG. 2 and in which the plate elements 90 are secured in the elastomer profiles 10, 10′. At the same time, the rail nut can be secured in the C-profile rail 45 by tightening the screw 40.

The first clamp part 1 has two web-shaped projections 29 that extend in the vertical direction to the second clamp part 2, parallel to the screw 40, and that form a stop for the second clamp part 2. In the clamping position (FIG. 2), the two projections 29 lie against the second clamp part 2, whereas they are at a distance from the second clamp part 2 when they are in the open position (FIG. 1).

The elastomer profile 10 (as well as also the symmetrically structured elastomer profile 10′) has an area 12 with a U-shaped cross section that serves for the insertion of a plate element 90. In the area of the side leg of the U-shaped area 12, the elastomer profile 10 is provided with a wavy structure that forms a contact surface for the plate element 90. Moreover, the elastomer profile 10 has an area 17 with a T-shaped cross section. The middle leg of this T-shaped area 17 is adjacent to the middle leg of the U-shaped area 12.

The head of the T-shaped area 17 is accommodated in an insertion groove 25 that is limited, on the one hand, by the web-shaped projection 29 and, on the other hand, by a first web 21 arranged on the clamp part 1 as well as by a second web 22 arranged on the clamp part 2. Since the T-shaped area 17 is accommodated in the insertion groove 25, the elastomer profile 10 is secured with a positive connection against slipping out sideways.

The webs 21 and 22 are arranged vertically one above the other. In the clamping position shown in FIG. 2, the two webs 21 and 22 clamp the elastomer profile 10 in a clamping section 14 that is configured on the middle leg of the T-shaped area 17. Since the clamping section 14 is clamped, the elastomer profile 10 is secured against slipping in the lengthwise direction of the webs 21 and 22 and is thus secured in the lengthwise direction of the clamp parts 1 and 2. However, if the clamp parts 1 and 2 are in the open position shown in FIG. 1, then at least one of the clamp parts 1 and 2, especially at least one of the webs 21 and 22, is at a distance from the clamping section 14 (in the embodiment shown, it is the upper web 22 that is at a distance). The elastomer profile 10 is thus released and can be moved along the webs 21 and 22 for assembly purposes.

In the clamping section 14, that is to say, in the middle leg of the T-shaped area 17, the elastomer profile has a hole 19 that extends along the two webs 21 and 22. This hole 19, which is arranged between the two webs 21 and 22, can absorb at least some of the deformations that occur when the elastomer profile 10 is clamped in the clamping position by the two clamp parts 1 and 2, and can thus at least reduce undesired deformations of the elastomer profile 10.

The two clamp parts 1 and 2 each have horizontally extending wing areas between which the two elastomer profiles 10 and 10′ are arranged.

On the side of the elastomer profile 10 facing the second clamp part 2, said elastomer profile 10 has a spring lip 5 that is preferably arranged adjacent to the web 22 and/or that runs along the web 22 and that rests on the second clamp part 2. This spring lip 5, which is arranged at the transition from the middle leg to the side leg of the U-shaped area 12 pushes the second clamp part 2 away from the U-shaped area 12 of the elastomer profile 10 and thus away from the first clamp part 1. Through the action of the spring lip 5, first of all, the clamp parts 1 and 2 are held in the open position as long as the screw 40 has not been not tightened. Secondly, the spring lip 5 pre-tensions the rail nut 41 on the first clamp part 1 by means of the screw 40, so that the rail nut 41 can be temporarily held in the C-profile rail 45 and has a temporary holding effect before the screw 40 is tightened.

Another embodiment of a clamp according to the invention is shown in FIG. 4. The embodiment shown in FIG. 4 differs from the embodiment shown in FIGS. 1 to 3 in that, according to FIG. 4, instead of two elastomer profiles 10 and 10′, only one single elastomer profile 10 is provided. Consequently, the embodiment shown in FIG. 4 is an edge clamp that is provided to secure a single plate element, whereas the embodiment shown in FIGS. 1 to 3 is a middle clamp that holds two plate elements.

What is claimed is:

1. A clamp for at least one plate element comprising:
a first clamp part;
a second clamp part, the first and second clamp parts adjustable relative to each other between an open position and a clamping position for the plate element; and
at least one elastomer section arranged for placement on the plate element between the two clamp parts,
the elastomer section having a clamping section clamped between the two clamp parts when the clamp parts are in the clamping position.

2. The clamp as recited in claim 1 wherein the elastomer section has an area with a U-shaped cross section for gripping the plate element.

3. The clamp as recited in claim 1 wherein the first clamp part has a web extending toward the second clamp part and clamping the clamping section when the first and second clamp parts are in the clamping position.

4. The clamp as recited in claim 1 wherein the elastomer section has an area with a T-shaped cross section having a middle leg, at least one part of the clamping section being located on the middle leg.

5. The clamp as recited in claim 4 wherein the first and second clamp parts each have a web extending toward the other clamp part, the first and second clap parts together with the two webs forming an insertion groove accommodating the area of the elastomer profile with the T-shaped cross section.

6. The clamp as recited in claim 1 wherein the elastomer section has at least one hole in a vicinity of the clamping section.

7. The clamp as recited in claim 1 wherein the first clamp part has at least one projection facing the second clamp part and limiting a movement of the second clamp part towards the first clamp part, the projection resting against the second clamp part when in the clamping position.

8. The clamp as recited in claim 1 wherein the elastomer section has a spring lip arranged in the area with a U-shaped cross section and pre-tensioning the first and second clamp parts.

9. The clamp as recited in claim 1 further comprising a screw passing through the first and second clamp parts, the screw being locked with a rail nut in order to secure the clamp to a rail.
